(19) United States
(12) Patent Application Publication
(10) Pub. No.: US 2024/0201954 A1
(43) Pub. Date: Jun. 20, 2024

(54) ENTROPY SOURCE WITH EMBEDDED COMPUTING METHOD FOR TRUE RANDOM NUMBER GENERATION

(71) Applicant: Commissariat à l'Energie Atomique et aux Energies Alternatives, Paris (FR)

(72) Inventors: Licinius-Pompiliu BENEA, Grenoble (FR); Romain WACQUEZ, Grenoble (FR); Florian PEBAY-PEYROULA, Grenoble (FR); Mikael CARMONA, Grenoble (FR)

(21) Appl. No.: 18/534,624

(22) Filed: Dec. 9, 2023

(30) Foreign Application Priority Data
Dec. 19, 2022 (FR) 2213801

(51) Int. Cl. G06F 7/58

(52) U.S. Cl. CPC G06F 7/588

(57) ABSTRACT

The present description concerns a device (1) comprising: a first oscillator (RO1) and a second oscillator (RO2) identical to the first one; a flip-flop (FF) delivering an output signal (S3) corresponding to a sampling of an output (S1) of the first oscillator (RO1) at a frequency of the second oscillator (RO2); a counter (COUNTER) supplying a value (N) equal to a number of periods of the second oscillator (RO2) counted during each period of the output signal (S3) of the flip-flop (FF); a first circuit (FB CTRL) modifying a period of one of the oscillators (RO1, RO2) based on the values (N) of the counter (COUNTER) so that an average difference between the periods of the oscillators is equal to a target difference; and a second circuit (PROCESS) characterizing an Allan variance on the output (O) of the counter based on said values (N).

### BACKGROUND

Many electronic circuits implement a function of true number generation (TRNG). For this purpose, these circuits have an entropy source from which is extracted random information. This random information is then used to generate true random numbers. As an example, the true random numbers thus obtained are used to generate encryption keys, signatures, etc.

In some of the above-described circuits, the entropy source is the clock jitter of a ring oscillator. Ring oscillators are widely used on behalf of their simplicity and of the strong knowledge of their theoretical models. The uncertainty (or jitter) regarding the real period of an output signal of a ring oscillator with respect to the theoretical period of this signal is used as a randomness source. This uncertainty increases with the number of accumulated periods (or, equivalently, the accumulation time).

The physical phenomena causing the jitter are well documented in literature. The model generally used as a theoretical basis is that provided by Hajimiri in the article “Jitter and phase noise in ring oscillators”, IEEE J. Solid-State Circuits, vol. 34, no 6, June 1999. This model defines the function of likeliness of the output signal of a ring oscillator to generate phase noise when confronted to a disturbance. More concretely, only a disturbance which has occurred during transient (rise or fall) phases of the output signal is capable of inducing a phase noise in this signal. Further, the model describes the effect of the different physical noise sources on the accumulated jitter. These phenomena appear as thermal noise resulting from the thermal agitation and as low-frequency noise (flicker) induced by the charge/discharge of the traps of the gate oxide of the metal oxide semiconductor (MOS) transistors forming the ring oscillator or by the diffusion of carriers in the channel of these transistors. Indeed, the accumulated jitter exhibits two regions: a region linearly varying with the variance of the jitter, which corresponds to the thermal noise, and a region quadratically varying with the variance of the jitter, which corresponds to the low-frequency noise (flicker). To use the jitter as an entropy source for the generation of true random numbers, only the thermal component of the jitter remains of interest since it is the only one which it truly random. Indeed, the low-frequency noise component (flicker) is not interesting since the low-frequency noise is auto-correlated and harmful as to the predictability of the generated randomness.

Thus, in the above-described circuits where the entropy source for generating true random numbers is based on the jitter of a ring oscillator, it is desirable to characterize the entropy source, that is, the jitter, to discriminate the amplitude of the thermal component of the jitter.

There exist embarked methods for characterizing, in a circuit, an entropy source based on the jitter of a first ring oscillator of the circuit by using a second oscillator of the circuit, which is identical to the first one.

A first method comprises measuring the number of oscillations of the first oscillator RO1 for Q oscillations of the second oscillator, factor Q being obtained by means of a frequency divider. This method is disclosed in the article “On the assumption of mutual independence of jitter realizations in P-TRNG stochastic models”, of P. Haddad, Y. Teglia, F. Bernard, and V. Fischer, presented at the “Design, Automation & Test in Europe Conference & Exhibition (DATE)”, in 2014, in Dresden.

The jitter is then characterized by using the Allan variance, that is, the variance calculated on the difference between two consecutive values, that is, here, two consecutive values available at the output of a counter rated by the output signal of the first oscillator and reset every Q periods of the output signal of the second oscillator by the output signal of the frequency divider by Q. The use of the Allan variance enables to overcome issues relative to the convergence of the models while respecting a stationary condition. The Allan variance is plotted against the number Q of accumulation periods and then follows a law (or curve or function) very similar to that of the previously-discussed model. More exactly, the Allan variance plotted against factor Q comprises a linear portion corresponding to the thermal noise, a quadratic portion corresponding to the flicker noise, and a noise floor corresponding to the quantization noise inherent to any acquisition. By performing a quadratic regression of the plotted curve to approximate it by a function of the type σ(Q)\hat{ }2=a0+a1.Q+a2.Q\hat{ }2, with σ(Q) the Allan variance according to accumulation Q, it is possible to obtain coefficients a0, a1, and a2 which represent the coefficients respectively for the quantization noise, for the thermal noise, and for the low-frequency noise (flicker). Obtaining coefficients a0, a1, and a2 thus amounts to characterizing the entropy source, that is, the jitter of the first oscillator.

However, this first method has the disadvantage that the contribution of the frequency divider circuit to the final noise is not known.

Further, in this first method, the characterization of the jitter of the first oscillator is implemented by a circuit arranged next to the processing of the entropy source, which requires a significant additional surface area.

A second method comprises sampling the output signal of the first oscillator with a synchronous D-type flip-flop (D flip-flop) rated at the frequency of the second oscillator. The output signal of the flip-flop then is a periodic signal having an average period Tm inversely proportional to the difference between the periods of the two oscillators. More particularly, the length of period Tm in number H of periods of the oscillator signal is such that H=T1/(T1−T2), with T1 and T2 the average value of the periods of the first and second oscillators, respectively. Then, a variance is calculated on the resultant of an XOR operation between two values of the output signal of the flip-flop separated from one another by G periods of the second oscillator. The variance according to G then has two portions, a portion linearly varying with G, which corresponds to the thermal noise, and a portion quadratically varying with G, which corresponds to the low-frequency noise (flicker). This method is disclosed in the article “Embedded Evaluation of Randomness in Oscillator Based Elementary TRNG”, of V. Fischer and D. Lubicz, presented in “Advanced Information Systems Engineering”, vol. 7908, Springer Berlin Heidelberg, 2014, p. 527 543. As previously, it is possible to characterize the entropy source, and thus the jitter of the first oscillator, by performing a quadratic regression of the variance plotted against G.

However, this second method has the disadvantage of being based on frequency ratios which are not controlled but imposed, and accordingly the accuracy of this second method is low and uncontrollable between different circuits.

Further, in this second method, as for the first method, the characterization of the jitter of the first oscillator is implemented by a circuit arranged next to the processing of the entropy source, which requires a significant additional surface area.

Thus, in the two above-described circuits and methods which enable to characterize an entropy source based on the jitter of a ring oscillator, to ensure a truly random randomness generation, have disadvantages. This is more generally the case of known circuits and methods enabling to characterize, in embedded fashion, the jitter of a ring oscillator, that is, enabling to characterize, in embedded fashion, an entropy source.

### SUMMARY

There exists a need to overcome all or part of the disadvantages of known circuits and of known methods implemented in these known circuits to characterize, in embedded fashion, an entropy source when the entropy source is based on the jitter of a ring oscillator.

An embodiment overcomes all or part of the disadvantages of known circuits and of known methods implemented in these known circuits to characterize, in embedded fashion, an entropy source when the entropy source is based on the jitter of a ring oscillator.

An embodiment provides an electronic device comprising:

an entropy source comprising:
a first ring oscillator and a second ring oscillator identical to the first ring oscillator, and
a synchronous flip-flop configured to supply an output signal corresponding to a sampling of an output of the first oscillator at a frequency of an output of the second oscillator;
a counter configured to supply, for each period of the output signal of the flip-flop, a value equal to a number of periods of the second oscillator counted during said period of the output signal of the flip-flop;
a first circuit configured to modify, during a first phase, a period of at least one of the two oscillators based on the values supplied by the counter so that an average difference between the periods of the two oscillators is equal to a target difference; and
a second circuit configured to receive the values supplied by the counter and to characterize, during
a second phase and based on said values, an Allan variance on the counter output.

According to an embodiment, the target difference is at least partly determined by a ratio of the jitter to the period of the first oscillator and/or by a target measurement accuracy.

According to an embodiment, the two oscillators are implemented in complementary metal-oxide semiconductor technology on fully depleted semiconductor on insulator, preferably on fully depleted silicon on insulator.

According to an embodiment, the first circuit is configured to control back gates of at least one delay element of at least one of the two oscillators to modify the average difference between the periods of the two oscillators.

According to an embodiment, the second circuit is configured, during the characterization of the Allan variance, to:
compute a first Allan variance value over a plurality of successive values supplied by the counter;
compute a second Allan variance value over a plurality of sums of K1 successive values supplied by the counter;
receive a third theoretical Allan variance value or compute a third Allan variance value over a plurality of sums of K2 successive values supplied by the counter; and
compute three coefficients of a quadratic curve characterizing the Allan variance based on at least said first, second, and third Allan variance values.

According to an embodiment, the second circuit is configured to add K successive values supplied by the counter and to deliver a least significant bit of said sum, K being determined by a minimum target entropy.

According to an embodiment, the device further comprises:
a first alarm circuit configured to compare with a first threshold each value supplied by the counter and to trigger a first alarm when said value is greater than the first threshold; and/or
a second alarm circuit configured to compute an Allan variance value based on the output values of the counter and a corresponding Allan variance value by using the Allan variance characterized by the second circuit, and then to compare a difference between these two calculated values with a second threshold and to trigger a second alarm if the difference between these two calculated values is greater than the second threshold.

Another embodiment provides method for characterizing an entropy source comprising:
a first ring oscillator and a second ring oscillator identical to the first ring oscillator, and
a synchronous flip-flop delivering an output signal corresponding to a sampling of an output of the first oscillator at a frequency of an output of the second oscillator, the method comprising:
supplying, with a counter and at each period of the output signal of the flip-flop, a value equal to a number of periods of the second oscillator counted during said period of the output signal of the flip-flop;
a first phase comprising modifying, with a first circuit and based on the values supplied by the counter, a period of at least one of the two oscillators so that an average difference between the periods of the two oscillators is equal to a target difference; and
a second phase comprising characterizing, by a second circuit and based on the values supplied by the counter, an Allan variance of the output of the counter.

According to an embodiment, the target difference is at least partly determined par a ratio of the jitter to the period of the first oscillator and/or by a target measurement accuracy.

According to an embodiment, the two oscillators are implemented in complementary metal-oxide semiconductor technology on fully depleted semiconductor on insulator, preferably on fully depleted silicon on insulator.

According to an embodiment, the first circuit controls back gates of at least one delay element of at least one of the two oscillators to modify the average difference between the periods of the two oscillators.

According to an embodiment, the Allan variance characterization comprises:
the computing, by the second circuit, of a first Allan variance value over a plurality of successive values supplied by the counter;
the computing, with the second circuit, of a plurality of sums of K1 successive values supplied by the counter and a second Allan variance value over said plurality of sums of K1 successive values;
the receiving, by the second circuit, of a third theoretical variance value or the computing, with the second circuit, of a plurality of sums of K2 successive values supplied by the counter and a third Allan variance value over said plurality of sums of K2 successive values; and the computing, by the second circuit, of three coefficients of a quadratic curve characterizing the Allan variance based at least on said first, second, and third Allan variance values.

According to an embodiment, the method further comprises a computing by the second circuit of a sum of K successive values supplied by the counter and a supply by the second circuit of a least significant bit of the sum, K being determined by a minimum target entropy.

According to an embodiment, the method further comprises:
the comparing, by a first alarm circuit, of each value supplied by the counter with a first threshold and the triggering, by the first alarm circuit, of a first alarm if a value supplied by the counter is greater than the threshold; and/or
the computing, by a second alarm circuit, of an Allan variance value based on the output values of the counter and of a corresponding Allan variance value by using the characterized Allan variance, the comparing, by the second alarm circuit, of a difference between the two calculated Allan variance values with a second threshold, and the triggering, by the second alarm circuit, of a second alarm if the difference is greater than the second threshold.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows a circuit according to an example of embodiment;

FIG. 2 illustrates, in a flowchart, an example of embodiment of a method of characterization of an entropy source of the circuit of FIG. 1;

FIG. 3 shows implementation details of a portion of the circuit of FIG. 1 according to an embodiment;

FIG. 4 implementation details of another portion of the circuit of FIG. 1 according to an embodiment;

FIG. 5 shows an embodiment of an alarm circuit usable in the circuit of FIG. 1; and

FIG. 6 shows an embodiment of another alarm circuit usable in the circuit de FIG. 1.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, usual methods and circuits using an entropy source for the generation of true random numbers have not been detailed, the embodiments and variants described herein being compatible with these usual methods and circuits.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

It is here provided to characterize, in embedded fashion, an entropy source based on the jitter of a first ring oscillator. For this purpose, there is provided a device comprising the first oscillator, a second oscillator identical to the first one, and a flip-flop sampling the output signal of the first oscillator at the frequency of the second oscillator. The device comprises a counter configured to measure the duration, in number N of periods T2 of the second oscillator, of each period T of the output signal of the flip-flop. The device further comprises a circuit configured to control, based on the output values of the counter, the period T1 of the first oscillator and/or the period T2 of the second oscillator so that the average number Nm of periods T2 per period T of the output signal of the flip-flop is equal to a target value, that is, a circuit configured to set the average period Tm of the output signal of the flip-flop to a target value. Still in other words, the circuit controls the difference between the value of period T1 and the value of period T2 to make it equal to a target difference, this target difference being at least partly determined by a ratio of the jitter of the first oscillator to its period T1 and/or by a target accuracy of the measurement of the jitter of the first oscillator by the second oscillator. The device further comprises another circuit configured to characterize, after period Tm has been set to the desired value, the jitter of the first oscillator based on the output values of the counter. More particularly, this circuit is configured to characterize the Allan variance on the counter output, that is, to compute the coefficients b0, b1, and b2 of a quadratic regression of the Allan variance according to accumulation Nm. As an example, to compute these coefficients, the circuit uses three Allan variance values to compute coefficients b0, b1, and b2, a first value computed on the output values of the counter, a second value computed based on the output values of the counter, and a third value, theoretical or obtained from the output values of the counter.

The fact of setting value Nm, and thus the difference between the values of periods T1 and T2, enables to avoid using a frequency divider having an influence on the measurement and to control the frequency ratios implemented to characterize the entropy source, that is, the jitter of oscillator RO1.

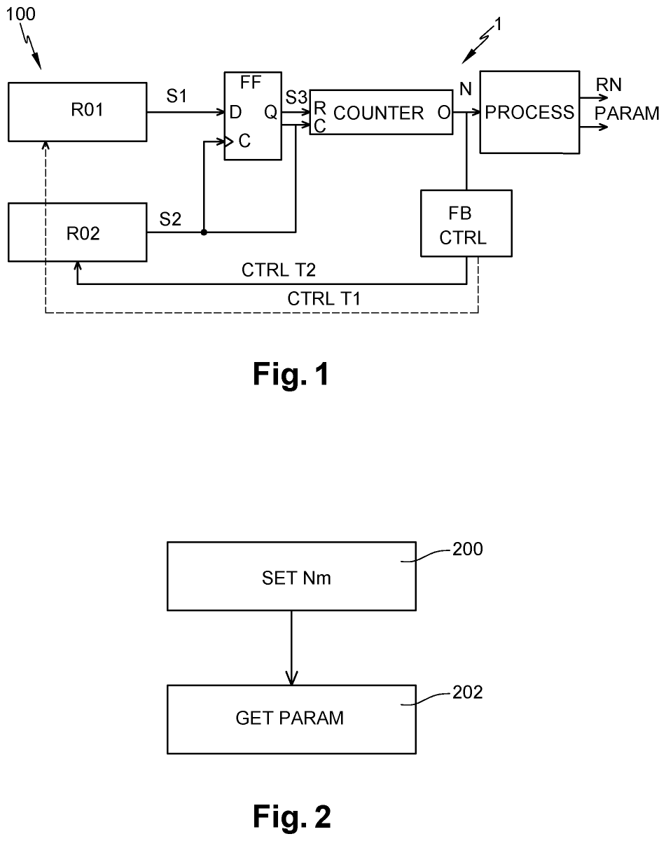

FIG. 1 schematically illustrates in the form of blocks an example of an embodiment of a circuit 1.

Circuit 1 comprises two identical ring oscillators RO1 and RO2. Oscillator RO1, respectively RO2, delivers a periodic output signal S1, respectively S2.

Circuit 1 further comprises a synchronous flip-flop FF, for example, of D type. Flip-flop FF is configured to sample signal S1 at the frequency of signal S2.

In other words, flip-flop FF is configured to update an output signal S3 at each beginning of a period of signal S2 with the binary value of signal S1, each beginning of a period of signal S2 corresponding to an active edge of signal S2, for example, a rising edge. Between two successive updates of signal S3, signal S3 is held at its current value, that is, the value taken by signal S3 during the first one of the two successive updates.

For example, flip-flop FF comprises a D data input configured to receive signal S1, a CK input for synchronizing (rating) the updates of signal S3 configured to receive signal S2, and a Q output configured to deliver signal S3.

The two oscillators RO1 and RO2 and flip-flop FF form an entropy source 100. The randomness extracted from entropy source 100 is generated based on the value of period T of signal S3. Signal S3 is a periodic signal having an average period Tm with an average duration Nm in number of periods of signal S2 inversely proportional to the difference between periods T1 and T2, according to formula Nm=T1/(T1−T2). Signal S3 has an instantaneous period T which varies with the jitter of signal S1. Thus, the measurement of period T, that is, of the duration of period T, is representative of the jitter of signal S1.

Entropy source 100 is a structure for example designated with abbreviation COSO (“COherent Sampling ring Ocillator”), which is used in coherent sampling ring oscillator true random number generator circuits (COSO).

To measure period T of signal S3, circuit 1 comprises a circuit (or counter) COUNTER. Circuit COUNTER is configured to supply, for each period T of signal S3, a value N, for example, in the form of a digital word, equal to the number of periods T2 of signal S2 counted during period T of signal S3. In other words, circuit COUNTER is configured to measure the duration of each period T of signal S3 in number N of periods T2 of signal S2.

As an example, circuit COUNTER comprises a reset input receiving signal S3, a synchronization input C receiving signal S2 and an output O supplying the counted values N. At each beginning of a period T2 of signal S2, for example, at each rising edge of signal S2, circuit COUNTER increments the current value of counting by one unit. At each beginning of a period T of signal S3, for example, at each rising edge of signal S3, circuit COUNTER resets the current counting value to zero. Preferably, the value N available at the output of circuit COUNTER, on output O, is updated based on the current counting value at each beginning of a period of signal S3, just before this current counting value is reset. In other words, the value N available at the output of circuit COUNTER is updated at each beginning of a period T of signal S3 with the value of the number of periods T2 of signal S2 counted during the previous period T.

Device 1 further comprises a circuit FB CTRL. Circuit FB CTRL is configured to control or modify the period of at least one of the two oscillators RO1 and RO2 so that the difference between periods T1 and T2 is equal to a target difference. The modification of the period T1 of oscillator RO1 and/or of the period T2 of oscillator RO2 by circuit FB CTRL is implemented based on the output values N of circuit COUNTER. For example, for a target value Nmt of the average number Nm of periods T2 per period T of signal S3, if output value N is smaller than Nmt, the difference between periods T1 and T2 is decreased, and if the output value N is greater than Nmt, the difference between periods T1 and T2 is increased.

According to an embodiment, the two oscillators RO1 and RO2 are implemented in complementary metal-oxide semiconductor technology on fully depleted semiconductor on insulator, preferably on fully depleted silicon on insulator. In such an embodiment, preferably, the modification of the period T1 of oscillator RO1, respectively of the period T2 of oscillator RO2, is implemented by controlling the back gates of at least one delay element, for example, an inverter, of oscillator RO1, respectively RO2.

In alternative embodiments, whether oscillators RO1 and RO2 are implemented in CMOS on FDSOI or not, the modification of the period T1 of oscillator RO1, respectively of the period T2 of oscillator RO2, is implemented otherwise, for example, by selecting a path of propagation of an oscillation among a plurality of possible paths, or by modifying the conditions of power supply of the oscillator. As an example, A. Peetermans, V. Rozic, and I. Verbauwheden's article entitled “A Highly-Portable True Random Number Generator Based on Coherent Sampling”, published in 2019 in 29th International Conference on Field Programmable Logic and Applications (FPL) discloses another example of setting of the relative periods of two ring oscillators.

However, the use of the back gates to modulate the period of at least one of oscillators RO1 and RO2 when they are implemented in CMOS on FDSOI allows a wider adjustment dynamic range and a better accuracy of the adjustment of the difference between periods T1 and T2.

In the example of FIG. 1, circuit FB CTRL only controls the period T2 of oscillator RO2 by means of a control signal CTRL T2. In an alternative embodiment, as illustrated in dotted lines in FIG. 1, circuit FB CTRL further controls the period T1 of oscillator RO1 by means of a control signal CTRL T1. In another variant, not illustrated, circuit CTRL FB only controls the period T1 of oscillator RO1 by means of signal CTRL T2.

In device 1, in each of oscillators RO1 and RO2, the ratio R of the period of the oscillator to its jitter can be determined and depends on the technology of implementation of the oscillators. For example, when the oscillators are implemented in CMOS on FDSOI, this ratio R is in the order of 1,000. In practice, for a given technology, this ratio may be obtained by a phase of characterization, for example, of a plurality of circuits.

Further, in device 1, the measurement accuracy is determined by the difference between periods T1 and T2. More concretely, the measurement accuracy is equal to 1/Nm.

A sufficient measurement accuracy is, for example, obtained when Nm is substantially equal to R. However, in other examples, a measurement accuracy where Nm is smaller than R may be sufficient. Those skilled in the art are capable of determining a target measurement accuracy according to the application. For example, for two oscillators RO1 and RO2 having periods T1 and T2 equal to 2 ps, to have a measurement accuracy of 1/1,000, the difference between periods T1 and T2 has to be set by circuit CTRL FB to 2 ns, that is, circuit CTRL FB for example has to set the period of oscillator RO1 to 2,002 ns and that of oscillator RO2 to 2,000 ns.

It can then be understood that the accuracy of the control of the periods T1 and/or T2 of the oscillators by circuit CTRL FB is determined by the target measurement accuracy. Taking the above-described case example, for oscillators RO1 and RO2 implemented in CMOS on FDSOI, the control signals CTRL T1 and CTRL T2 of the back gates have to be able to be modified with an accuracy in the order of one mV to obtain the target difference equal to 2 ns in this example.

Device 1 further comprises a circuit PROCESS. Circuit PROCESS is configured, once average period Tm has been set by circuit FB CTRL, to characterize or determine or discriminate the characteristics of the jitter, for example, by using the Allan variance on the output values N of circuit COUNTER based on the output values N of the counter, and, more exactly, based on a plurality of successive output values N of circuit COUNTER. In practice, determining the characteristics of the jitter by using the Allan variance on the output values N of circuit COUNTER amounts to characterizing entropy source 100, that is, to characterizing the jitter of oscillator RO1. Further, the characterization of the Allan variance comprises determining the coefficients b0, b1, and b2 of the quadratic curve b0+b1.Q+b2.Q\hat{ }2 of the variation of the Allan variance of the output values of circuit COUNTER against accumulation Q.

Indeed, the output values N of circuit COUNTER vary around value Nm according to the jitter of oscillator RO1 accumulated over Q equal Nm periods of signal T2, and can thus be directly used to characterize the Allan variance over the output values N of circuit COUNTER, that is, to determine or compute coefficients b0, b1, and b2.

According to an embodiment, a first Allan variance value may be directly computed on the outputs N of circuit COUNTER, by computing the variance over the difference between two successive values N for a set of a plurality of N successive values. This first value corresponds to an accumulation Q equal to Nm, thus to a first point of the quadratic curve b0+b1.Q+b2.Q\hat{ }2 of the variation of the Allan variance against the accumulation.

According to an embodiment, to compute or determine coefficients b0, b1, and b2, circuit PROCESS is configured to compute at least two other Allan variance values, or two other points, corresponding to two other accumulation values Q, based on the output values N of circuit COUNTER. Circuit PROCESS is then configured to compute Allan variance values for any accumulation value Q equal to P.Nm, with P a positive integer. For this purpose, circuit PROCESS is configured to store successive values N in successive groups of P successive values N, and to add, in each group, the P values. The result of each sum provides a second value and circuit PROCESS is then configured to compute the Allan variance over these second values, the Allan variance thus computed corresponding to an accumulation Q equal to P.Nm. Preferably, the groups of P first successive values are non-overlapping and adjacent, that is, when P successive values are stored in a group, the next P successive values N are stored in the next group, and no value N belongs to two groups at a time. In this embodiment, the three Allan variance values are all derived from output values N of circuit COUNTER, a first Allan variance value being directly calculated over values N (for an accumulation value Q=Nm), a second Allan variance value being calculated based on values N (using a first value K1 of factor P, for an accumulation value Q=K1.Nm), and a third Allan variance value being calculated based on values N (using a second value K2 of factor P, for an accumulation value Q=K2.Nm).

According to an embodiment, based on at least three Allan variance values corresponding to different Q accumulation values, circuit PROCESS is configured to compute coefficients b0, b1, and b2.

According to an embodiment, circuit PROCESS determines coefficients b0, b1, and b2 by calculating three Allan variance values corresponding to three different accumulation values Q comprising, for example, value Q=Nm, and by solving a system of three equations with three unknowns.

According to an alternative embodiment, circuit PROCESS determines coefficients b0, b1, and b2 by computing two Allan values variance corresponding to two different accumulation values Q comprising, for example, value Q=Nm, by obtaining a third theoretical Allan variance value for a third accumulation value Q, and by solving a system of three equations with three unknowns. As an example, this third theoretical value originates from information stored in device 1, for example, in a memory of device 1.

According to an alternative embodiment, circuit PROCESS determines coefficients b0, b1, and b2 by performing a quadratic regression based on more than three Allan values, each corresponding to a different accumulation value Q. These Allan variance values are all computed by circuit PROCESS, except, for example, one of these values, which is a theoretical value directly obtained by circuit PROCESS, for example, based on information stored in device 1, for example, in a memory of device 1.

It should however be noted that the determination of coefficients b0, b1, and b2 by the implementation of a quadratic regression based on more than three Allan variance values corresponding to different values Q is more complex and requires more computing resources than the determination of coefficients b0, b1, and b2 by solving a system of three equations with three unknowns by means of only three distinct Allan variance values.

As an example, hardware blocks (or circuits) enabling to compute an Allan variance value over a set of a plurality of successive values are known and disclosed, for example, at page 202 of the document “Characterisation, evaluation and use of clock jitter as a source of randomness in data security” of E. N. Allini.

When circuit PROCESS uses three Allan variance values computed by circuit PROCESS (or two Allan variance values computed by circuit PROCESS and a third theoretical Allan variance value obtained by circuit PROCESS), and that these three Allan variance values correspond to accumulation values Q respectively equal to Nm, to K1.Nm, and K2.Nm, preferably coefficients K1 and K2 are selected to have a logarithmic scaling of the three accumulation values Q.

As an example, calling v1 the Allan variance computed for Q equal to Nm, v2 the Allan variance computed for Q equal to K1.Nm, and v3 the Allan variance computed for Q equal to K2.Nm, the system of three equations with three unknowns solved by circuit PROCESS is the following:

$$v 1 = b 0 + b 1 . N m + b 2. Nm \hat{} 2 ,$$

$$v 2 = b 0 + b 1. K 1. Nm + b 2. ( K 1. Nm ) \hat{} 2 ,$$

$$v 3 = b 0 + b 1. K 2. Nm + b 2. ( K 2. Nm ) \hat{} 2.$$

According to an embodiment, to simplify computing operations, K2 is selected to be equal to the squared value of K1, whereby the system to be solved becomes:

$$v 1 = b 0 + b 1 . Nm + b 2. Nm \hat{} 2 ,$$

$$v 2 = b 0 + b 1. K 1. Nm + b 2. ( K 1. Nm ) \hat{} 2 ,$$

$$v 3 = b 0 + b 1. K 1 \hat{} 2. Nm + b 2. ( K 1 \hat{} 2. Nm ) \hat{} 2.$$

Once circuit PROCESS has characterized the Allan variance on the output of circuit COUNTER, that is, it has determined coefficients b0, b1, and b2, circuit PROCESS delivers an output PARAM indicating the values b0, b1, and b2 computed by circuit PROCESS.

For example, the thermal noise component S_thermique can then be computed based on coefficients b0, b1, and b2, for example, by using the following equation:

$$( S\_thermique / Nm ) \hat{} 2 = b 1 / Nm .$$

FIG. 2 illustrates, in a flowchart, an example of embodiment of a method for characterizing the entropy source 100 of the circuit 1 of FIG. 1, that is, the jitter of the oscillator RO1 of the circuit 1 of FIG. 1. Unless specified otherwise, all that has been described in relation with FIG. 1 applies to the method described in relation with FIG. 2.

At a first step, or phase, 200 (block “SET Nm”), circuit CTRL FB adapts or modifies the period of at least one of oscillators RO1 and RO2 based on the output values N of circuit COUNTER so that the difference between periods T1 and T2 is equal to a target difference, or, in other words, so that the average duration Nm of the period T of signal S2 in number of periods T2 of signal S2 is equal to a target value.

Once this setting has been obtained, at a next step, or phase, 202 (block “GET PARAM”), circuit PROCESS computes the coefficients b0, b1, and b2 of function b0+b1.Q+b2.Q describing the variation of the Allan variance on the outputs of circuit COUNTER according to accumulation Q. Coefficients b0, b1, and b2, that is, the output PARAM du circuit PROCESS, characterize the Allan variance, that is, entropy source 100 and the jitter of oscillator RO1.

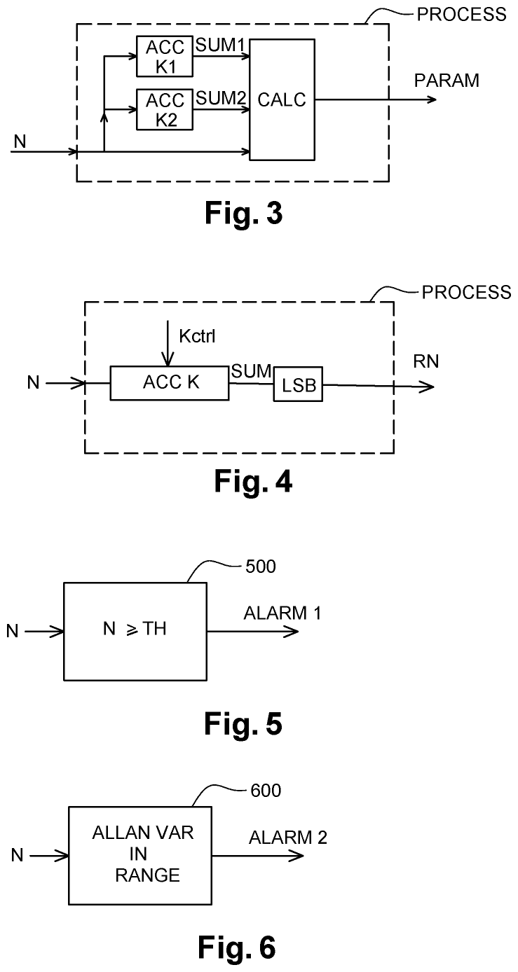

FIG. 3 shows details of implementation of a portion of the circuit 1 of FIG. 1 according to an embodiment, and, more particularly, details of implementation of circuit PROCESS according to an embodiment.

In the embodiment of FIG. 3, circuit PROCESS is configured to compute:
a first Allan variance value v1 directly over the successive output values N of circuit COUNTER, value v1 corresponding to an accumulation value Q equal to Nm;
a second Allan variance value v2 based on values derived from the successive values N, that is, from a plurality of sums of K1 successive values N, value v2 then corresponding to an accumulation value Q equal to K1.Nm; and
a third Allan variance value v3 based on other values derived from the successive values N, that is, from a plurality of sums of K2 successive values N, value v3 then corresponding to an accumulation value Q equal to K2.Nm.

Circuit PROCESS is then configured to compute coefficients b0, b1, and b2 characterizing the Allan variance. More particularly, coefficients b0, b1, and b2 characterize the variation of the Allan variance according to accumulation Q, that is, they characterize the entropy of entropy source 100, or, in other words, the jitter of oscillator RO1.

For this purpose, circuit PROCESS receives the successive output values N of circuit COUNTER (not shown in FIG. 3).

These successive values N are supplied to a circuit CALC of circuit PROCESS configured to compute, based on these successive values N, a value v1 of the Allan variance corresponding to an accumulation Q equal to Nm.

These successive values N are also supplied to a circuit ACC K1 of circuit PROCESS. Circuit ACC K1 is configured to compute a plurality of sums SUM1 of K1 successive values N. For example, circuit ACC K1 is configured, as it receives the successive values N, to add K1 successive values, deliver a value SUM1 resulting from this sum, and then to resume this operation of addition of K1 successive values N to generate a value SUM1 on each next group of K1 successive values N.

Circuit CALC receives values SUM1. Circuit CALC is configured to compute, based on the successive values SUM1 generated, by circuit ACC K1, based on the successive values N, a value v2 of the Allan variance corresponding to an accumulation Q equal to K1.Nm.

The successive values N received by circuit PROCESS are also supplied to a circuit ACC K2 of circuit PROCESS. Circuit ACC K2 is configured to compute a plurality of sums SUM2 of K2 successive values N. For example, circuit ACC K2 is configured, as it receives the successive values N, to add K2 successive values, to deliver a value SUM2 resulting from this addition, and then to resume this operation of addition of K2 successive values N to generate a value SUM2 on each next group of K2 successive values N.

Circuit CALC receives values SUM2. Circuit CALC is configured to compute, based on the successive values SUM2 generated, by circuit ACC K2, based on the successive values N, a value v3 of the Allan variance corresponding to an accumulation Q equal to K2.Nm.

Finally, circuit CALC is configured to compute coefficients b0, b1, and b2 based on the Allan variance values v1, v2, and v3. For example, circuit CALC is configured to solve the system of three equations with three unknowns previously discussed in relation with FIG. 1.

Circuit PROCESS, for example, its circuit CALC, then delivers output PARAM indicating the value of coefficients b0, b1, and b2.

As an alternative embodiment not illustrated, when circuit CALC is configured to compute value v1, value v2 and coefficients b0, b1, and b2 based on values v1, v2 and a third value v3′ where value v3′ is a theoretical Allan variance value directly supplied to circuit CALC, circuit ACC K2 is omitted. This enables to simplify the implementation of circuit CALC but may however induce a measurement error on the computing of coefficients b0, b1, and b2.

Although this is not illustrated herein, in still another alternative embodiment, circuit PROCESS is configured to compute more than three Allan variance values corresponding to different accumulation values Q, and to determine coefficients b0, b1, and b2 based on these Allan variance values by implementing a quadratic regression. However, in this case, circuit PROCESS will be more bulky and more complex than that of FIG. 5 or of the alternative embodiment with three Allan variance values v1, v2, and v3′.

An advantage of having characterized the Allan variance is that it is then possible to determine a positive integer value K for which the accumulation Q=K.Nm of the jitter of oscillator RO1 is sufficient to generate a random bit with a minimum target entropy Htarget. This value K may be computed by applying Baudet's model disclosed in the document “On the Security of Oscillator-Based Random Number Generators”, of M. Baudet, D. Lubicz, J. Micolod, and A. Tassiaux, published in J Cryptol, vol. 24, no 2, p. 398 425, Apr. 2011.

For example, it is possible to link the minimum target entropy Htarget, factors K1 and K2, value K, and values v1, v2, and v3 by means of the following inequality:

$$K > ln [ ( 1 - Htarget ) / 0.584 ] . ( N m + 1 ) .$$

$$[ ( v 2 - v 1 ) . ( K 2 \hat{} 2 - 1 ) - ( v 3 - v 1 ) . ( K 1 \hat{} 2 - 1 ) ] / [ 39.478 . Nm \hat{} 3. ( k 1 - 1 ) . ( k 2 - 1 ) . ( k 2 - k 1 ) ]$$

Once this value K has been set, to obtain a random bit RN with an entropy greater than or equal to target entropy Htarget, it is sufficient to add K successive values N, and bit RN then is the least significant bit of the result of this sum.

The optional step of determination of value K based on a minimum target entropy Htarget, and of addition of K successive values N to obtain random bit RN is for example implemented after the step 202 of FIG. 2. This optional step is further, for example, implemented by the circuit PROCESS of circuit 1 as shown in FIG. 1 where circuit PROCESS delivers random bit RN.

FIG. 4 shows details of implementation of another portion of the circuit 1 of FIG. 1 according to an embodiment. More particularly, FIG. 4 illustrates implementation details of circuit PROCESS according to an embodiment where circuit PROCESS is configured to supply the bit RN corresponding to the least significant bit of the sum of K successive values N.

Circuit PROCESS then comprises a circuit ACC K. Circuit ACC K is configured to receive the successive output values N of circuit COUNTER (not shown in FIG. 4), to add to one another the K values of each set of K successive values N, and to supply the result SUM of this operation. As an example, circuit ACC K is controlled by a signal Kctrl indicating the value K to be used.

Bit RN then corresponds to the least significant bit of result SUM. As an example, circuit PROCESS then implements a function of selection of the least significant bit of result SUM, for example, by means of a circuit LSB receiving signal SUM and delivering bit RN.

These details of implementation of circuit PROCESS when the latter is configured to supply bit RN are compatible with the details of implementation of circuit PROCESS described in relation with FIG. 3.

Optionally, according to an embodiment, device 1 further comprises one or a plurality of alarm circuits configured to detect one or a plurality of malfunctions of device 1. Each step of detection of a malfunction is, for example, implemented in the method described in relation with FIG. 2, for example, after step 202.

FIG. 5 shows an embodiment of an alarm circuit 500 implemented in the circuit 1 of FIG. 1.

In this embodiment, circuit 500 (block “N≥TH” in FIG. 5) is configured to detect a locking of signal S3, that is, when signal S3 no longer periodically varies over time with an average period Tm as previously described. This situation for example results from the fact that one of the two oscillators RO1 and RO2 locks on the other of the two oscillators RO1 and RO2, which results in a signal S3 having a constant (high or low) state. This situation may also be the result of an attack of device 1 by a pirate.

To detect such a locking of signal S3, circuit 500 is configured to receive the output values N of circuit COUNTER, and to compare each received value N with a threshold TH. The threshold is higher than value Nm, for example, at least twice higher than value Nm. In other words, threshold TH is determined by the target difference used at step 200 (FIG. 2).

If one of the received values N exceeds threshold TH, this means that signal S3 is in a locked situation, and circuit 500 is then configured to supply an alarm signal ALARM1.

As an example, when a signal ALARM1 is transmitted by circuit 500, circuit 1 is configured to reset oscillators RO1 and RO2, for example, by blocking with a control signal the propagation of oscillations in these oscillators before allowing this propagation again. After such a step of resetting of oscillators RO1 and RO2, at least the step 200 of the method of characterization of entropy source 100 is implemented.

FIG. 6 shows an embodiment of another alarm circuit 600 implemented in the circuit 1 of FIG. 1.

In this embodiment, circuit 600 (block “ALLAN VAR IN RANGE?” in FIG. 6) is configured to detect a modification of the operation of oscillators RO1 and RO2 resulting, for example, from operating temperature variations, from the aging of the circuit.

For this purpose, circuit 600 receives the successive output values N of circuit COUNTER, and is configured to compute sums SUM3 of K3 successive values, and to compute an Allan variance value v4 over the successive values SUM3. Circuit 600 is further configured to compare value v4 with a variance value V4 computed based on the coefficients b0, b1, and b2 determined at 200 and on an accumulation value Q equal to K3.Nm. If the difference between values v4 and V4 is greater than a threshold, this signifies that the operation of oscillators RO1 and RO2 has been modified since the implementation of step 200 and that the coefficients b0, b1, and b2 determined during this step are no longer valid.

According to an embodiment, value K3 is selected to be equal to the value K used to generate bit RN. This enables to use the circuit ACC K of circuit PROCESS again, which then directly supplies values SUM. In alternative embodiments, value K3 is different from value K, but is preferably selected to correspond to an accumulation value Q for which the Allan variance determined at step 200 is in the region dominated by the thermal noise.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. Electronic device comprising:
an entropy source comprising:
a first ring oscillator and a second ring oscillator identical to the first ring oscillator, and
a synchronous flip-flop configured to supply an output signal-corresponding to a sampling of an output of the first oscillator at a frequency of an output of the second oscillator;
a counter configured to supply, for each period of the output signal of the flip-flop, a value equal to a number of periods of the second oscillator-counted during said period of the output signal of the flip-flop;
a first circuit configured to modify, during a first phase, a period of at least one of the two oscillators based on the values supplied by the counter so that an average difference between the periods of the two oscillators is equal to a target difference; and
a second circuit configured to receive the values supplied by the counter and to characterize, during a second phase and based on said values, an Allan variance on the output of the counter.

2. Device according to claim 1, wherein the target difference is at least partly determined by a ratio of the jitter to the period of the first oscillator and/or by a target measurement accuracy.

3. Device according to claim 1, wherein the two oscillators are implemented in complementary metal-oxide semiconductor technology on fully depleted semiconductor on insulator, preferably on fully depleted silicon on insulator.

4. Device according to claim 3, wherein the first circuit is configured to control back gates of at least one delay element of at least one of the two oscillators to modify the average difference between the periods of the two oscillators.

5. Device according to claim 1, wherein the second circuit is configured, during the characterization of the Allan variance, to:
compute a first Allan variance value over a plurality of successive values supplied by the counter;
compute a second Allan variance value over a plurality of sums of K1 successive values supplied by the counter;
receive a third theoretical Allan variance value or compute a third Allan variance value over a plurality of sums de K2 successive values supplied by the counter; and
compute three coefficients of quadratic curve characterizing the Allan variance based on at least said first, second, and third Allan variance values.

6. Device according to claim 1, wherein the second circuit is configured to add K successive values supplied by the counter and to deliver a least significant bit of said sum, K being determined by a minimum target entropy.

7. Device according to claim 1, wherein the device further comprises:
a first alarm circuit configured to compare with a first threshold each value supplied by the counter and to trigger a first alarm when said value is greater than the first threshold; and/or
a second alarm circuit configured to compute an Allan variance value based on the output values of the counter and a corresponding Allan variance value by using the Allan variance characterized by the second circuit, and then to compare a difference between these two computed values with a second threshold and to trigger a second alarm if the difference between these two computed values is greater than the second threshold.

8. Method for characterizing an entropy source comprising:
a first ring oscillator and a second ring oscillator identical to the first ring oscillator, and
a synchronous flip-flop delivering an output signal corresponding to a sampling of an output of the first oscillator at a frequency of an output of the second oscillator,
the method comprising:
the supplying, with a counter and at each period of the output signal of the flip-flop, a value equal to a number of periods of the second oscillator-counted during said period of the output signal of the flip-flop;
a first phase comprising modifying, with a first circuit and based on the values supplied by the counter, a period of at least one of the two oscillators so that an average difference between the periods of the two oscillators is equal to a target difference; and
a second phase comprising the characterization, by a second circuit and based on the values supplied by the counter, of an Allan variance of the output of the counter.

9. Method according to claim 8, wherein the target difference is at least partly determined by a ratio of the jitter to the period of the first oscillator and/or by a target measurement accuracy.

10. Method according to claim 8, wherein the two oscillators are implemented in complementary metal-oxide semiconductor technology on fully depleted semiconductor on insulator, preferably on fully depleted silicon on insulator.

11. Method according to claim 10, wherein the first circuit-controls back gates of at least one delay element of at least one of the two oscillators to modify the average difference between the periods of the two oscillators.

12. Method according to claim 8, wherein the Allan variance characterization comprises:
the computing, by the second circuit, of a first Allan variance value over a plurality of successive values supplied by the counter;
the computing, with the second circuit, of a plurality of sums of K1 successive values supplied by the counter and a second Allan variance value over said plurality of sums of K1 successive values;
the receiving, by the second circuit, of a third theoretical variance value or the computing, with the second circuit, of a plurality of sums of K2 successive values supplied by the counter and a third Allan variance value over said plurality of sums of K2 successive values; and
the computing, by the second circuit, of three coefficients of a quadratic curve characterizing the Allan variance based on at least said first, second, and third Allan variance values.

13. Method according to claim 8, wherein the method further comprises a computing by the second circuit of a sum of K successive values supplied by the counter and a delivery by the second circuit of a least significant bit of the sum, K being determined by a minimum target entropy.

14. Method according to claim 8, wherein the method further comprises:
the comparing, by a first alarm circuit, of each value supplied by the counter with a first threshold and the triggering, by the first alarm circuit, of a first alarm if a value supplied by the counter is greater than the threshold; and/or
the computing, by a second alarm circuit, of an Allan variance value based on the output values of the counter and a corresponding Allan variance value by using the characterized Allan variance, the comparing, by the second alarm circuit, of a difference between the two computed Allan variance values with a second threshold, and the triggering, by the second alarm circuit, of a second alarm if the difference is greater than the second threshold.
